(19) United States
(12) Patent Application Publication
(10) Pub. No.: US 2020/0077794 A1
(43) Pub. Date: Mar. 12, 2020

(54) GUIDE DEVICE

(71) Applicant: Schock Metallwerk GmbH, Urbach (DE)

(72) Inventor: Joachim ZIMMERMANN, Schorndorf (DE)

(73) Assignee: Schock Metallwerk GmbH, Urbach (DE)

(21) Appl. No.: 16/683,835

(22) Filed: Nov. 14, 2019

Related U.S. Application Data
(63) Continuation of application No. PCT/EP2018/063103, filed on May 18, 2018.

(30) Foreign Application Priority Data
May 18, 2017 (DE) 10 2017 208 450.2

(51) Int. Cl. A47B 88/487; B60N 2/75; B60N 2/02; A47B 88/457; A47B 88/473; A47B 88/437

(52) U.S. Cl. CPC A47B 88/487; B60N 2/773; B60N 2/0232; B60N 2002/0236; A47B 88/473; A47B 88/437; A47B 88/457

(57) ABSTRACT

In order to provide a guide device which is easy to build and enables efficient influencing of movement, it is proposed that the guide device comprises the following: at least two guide rails (112), which are movable relative to one another by means of a rolling element arrangement (12); and a movement device (134) for influencing the movement of the at least two guide rails (112) relative to one another.

### RELATED APPLICATION

This application is a continuation of international application No. PCT/EP2018/063103 filed on May 18, 2018, and claims the benefit of German application No. 10 2017 208 450.2 filed on May 18, 2017, which are incorporated herein by reference in their entirety and for all purposes.

### FIELD OF DISCLOSURE

The present invention relates to a guide device for displaceably mounting an object on a further object. Such guide devices are known for example from the field of furniture-making for the guiding of drawers.

### SUMMARY OF THE INVENTION

The object of the present invention is that of providing a guide device which is easy to build and enables efficient influencing of movement.

The object is achieved in accordance with the invention by a guide device in accordance with claim 1.

In one embodiment of the invention it is provided that the guide device for displaceably mounting an object on a further object comprises the following:

at least two guide rails, which are movable relative to one another by means of a rolling element arrangement;

a movement device for influencing the movement of the at least two guide rails relative to one another.

The guide device preferably comprises precisely two guide rails, or three or more than three guide rails.

It may be advantageous if each guide rail has a substantially C-shaped cross section and comprises a rail back, from which two limbs provided with rolling element races protrude laterally.

It may also be provided that only one or only two guide rails have a substantially C-shaped cross section and comprise a rail back, from which two limbs provided with rolling element races protrude laterally.

It may be favourable if the movement device comprises a first coupling element and a second coupling element.

The first coupling element and the second coupling element are preferably coupled or couplable to one another, in particular are brought into engagement or are bringable into engagement with one another directly, in order to influence the movement of the at least two guide rails relative to one another.

The first coupling element is preferably secured directly on or relative to a first guide rail or is formed by a portion or part of the first guide rail.

Alternatively or additionally, it may be provided that the second coupling element is secured directly on or relative to a second guide rail or is formed by a portion or part of the second guide rail.

The guide rails are displaceable relative to one another with respect to a displacement direction.

In particular, a linear displacement is provided.

The coupling elements are preferably displaceable, in particular linearly displaceable, relative to one another with respect to the displacement direction.

It may be provided that one of the coupling elements performs or experiences a further movement additionally to the linear displacement movement.

In particular it may be provided that one of the coupling elements is rotatable. One or more coupling elements are secured to the corresponding guide rail preferably by means of a clipped connection, a latched connection, a screwed connection, an adhesively bonded connection, a welded connection and/or a riveted connection and/or by plastics moulding.

It may also be provided that a movement unit, in particular damping unit or drive unit, of the movement device is secured to one guide rail or both guide rails by means of a clipped connection, a latched connection, a screwed connection, an adhesively bonded connection, a welded connection and/or a riveted connection.

At least one of the coupling elements extends preferably at least over a maximum displacement path of the guide device. The coupling elements are hereby coupled or couplable to one another preferably continuously over the entire displacement path.

Alternatively it may be provided that the coupling elements are coupled or couplable to one another only in some sections over the displacement path.

The maximum displacement path is given preferably by a movement of a guide rail relative to the further guide rail from a stop (end position) at one end along the displacement direction to a stop (end position) at a further end along the displacement direction.

The at least one coupling element extends preferably in such a way and is arranged preferably in such a way that the at least one further coupling element is bringable into engagement, or is in engagement with the further coupling element with any arbitrary positioning of the guide rails relative to one another, in particular between the two end positions.

For example, in the case of a coupling element formed as a toothed rack it may be provided that the coupling element is provided with teeth over the maximum displacement path.

Alternatively, it may be provided that the coupling element is provided with teeth only in some sections, for example in one or more portions, whereas one or more further portions have no teeth.

It may also be provided that the coupling element formed for example as a toothed rack extends only over a portion of the maximum displacement path.

It may be advantageous if at least one of the coupling elements, in particular a coupling element formed as a toothed rack, comprises a transition region, by means of which the bringing into engagement of the two coupling elements and/or a bringing out of engagement of the two coupling elements is facilitated or made possible. For example, an increasing tooth height of the teeth of a toothed rack and/or an oblique orientation of the toothed rack relative to the displacement direction may be provided. A blocking of the movement device as the two coupling elements are brought into engagement can hereby be avoided.

It may be favourable if the movement device comprises at least one coupling element which is arranged, in particular secured, on a rail back of one of the guide rails and/or on a limb of one of the guide rails.

The at least one coupling element is preferably arranged, in particular secured, in an interior between the two guide rails and/or in an intermediate space between two limbs of one of the guide rails or both guide rails.

It may be favourable if at least one coupling element is arranged on an inner side of a limb of a guide rail. In particular for tolerance compensation, a gap for example of at most approximately 5 mm, for example at most approximately 3 mm, in particular at most approximately 1 mm, may be provided here between the coupling element and the limb.

In particular under heavy loading of the coupling element, said coupling element may then abut against the limb and be supported hereby.

A side of the limb facing the coupling element is in particular an inner side and/or a side facing away from a rolling element race of the limb.

It may furthermore be provided that at least one coupling element is biased by means of a spring device, for example by means of at least one leaf spring, against and/or in the direction of at least one further coupling element and/or is supported against a deflection by the at least one further coupling element. For example, a spring device may be arranged between a coupling element formed as a toothed rack on the one hand and a limb of a guide rail on the other hand.

Alternatively or additionally, it may be provided that a coupling element formed as a toothed wheel is biased by means of a spring device against and/or in the direction of at least one further coupling element and/or is supported against a deflection by the at least one further coupling element.

The movement device comprises in particular a coupling element formed as a rotary element, in particular as a toothed wheel, and/or one or more coupling elements formed as linear elements, in particular as toothed racks.

The rotation axis of the rotary element runs preferably at least approximately perpendicularly to a plane of extent, parallel to which at least one rail back of at least one guide rail extends.

Alternatively, it may be provided that a rotation axis of the rotary element runs at least approximately parallel to a plane of extent, parallel to which at least one rail back of at least one guide rail extends.

In addition, the rotation axis of the rotary element may be oriented running obliquely to the plane of extent.

It may be favourable if the movement device comprises one, two or more than two coupling elements, which are arranged fully within an intermediate space formed between the at least two guide rails.

The intermediate space is delimited in particular by the two rail backs and the limbs of the guide rails.

In particular in the fully inserted state of the guide device, which in particular is a state in which the two guide rails overlap one another maximally, the one, the two or the more than two coupling elements are arranged preferably fully within the intermediate space.

It may also be provided that one, two or more than two coupling elements are arranged partially or fully outside the intermediate space.

The movement device preferably comprises a damping device and/or a drive device or is formed as a damping device and/or as a drive device.

A damping device preferably comprises a damping unit.

In this description and the accompanying claims, the term “damping” shall be understood to mean the effect of braking and/or decelerating and/or bringing to a standstill and/or holding at standstill.

A damping effect is preferably selected such that, with increasing acceleration of the guide rails relative to one another, a counter force provided as a result of the damping also increases.

It may be favourable if, by the damping device, a breakaway torque which must be overcome in order to set the guide rails in motion relative to one another is increased, for example by a factor of 10, in particular 50, preferably 100, compared with a breakaway torque which the guide rails have with the rolling element arrangement without movement device.

The displacement force that must be exerted in order to displace the guide rails relative to one another, for example in order to move them at a relative speed of approximately 0.1 m/s, 1 m/s or 10 m/s, is preferably adjustable and/or selectable and/or controllable by means of the damping device.

An at least approximately constant displacement force and/or a constant resistance to the movement of the guide rails over the entire displacement path (course of movement), in particular at constant displacement speed, is provided by the damping device.

A drive device comprises in particular a drive unit.

The damping unit and/or the drive unit are preferably integrated in a rail back of a guide rail.

The rail back for this preferably comprises an opening, in which the damping unit and/or drive unit is mounted or is mountable.

The damping unit and/or drive unit preferably terminates flush with an outer side of the rail back facing away from the intermediate space.

The coupling element is connected to the damping unit and/or the drive unit preferably by means of a shaft.

For example, a fluid damper, in particular a liquid damper, may be provided as damping unit.

In particular an electric motor is provided as drive unit.

It may be provided that the guide device comprises a self-closing device, by means of which the guide rails can be brought into a fully retracted position.

It may also be provided, however, that the guide device does not comprise a self-closing device.

It may be advantageous if the guide device comprises one or more detent devices for latching the guide rails in different positions relative to one another.

The guide rails are formed preferably mirror-symmetrically with respect to a longitudinal median plane running perpendicularly to rail backs of the two guide rails and along a displacement direction.

The guide device according to the invention is suitable in particular for use in a displacement system.

The present invention therefore relates also to a displacement system which comprises at least two objects and a guide device, in particular a guide device according to the invention. The guide device is used in particular to mount one of the two objects on the further of the two objects so as to be displaceable relative to the further object.

The displacement system may also comprise two or more guide devices, in particular guide devices according to the invention, in particular for mounting the one object on the further of the two objects.

It may be provided here that only one of the guide devices comprises a movement device, in particular a damping device and/or drive device.

It may be provided that one of the guide devices comprises a movement device formed as a damping device, whereas the further of the guide devices for example comprises a movement device formed as a drive device.

The guide device is preferably arranged between the two objects with respect to the direction of gravity.

One or more rail backs of guide rails of the guide device, in particular the planes of extent, is/are preferably oriented substantially perpendicularly to the direction of gravity or obliquely hereto.

In particular it may be provided that the one or more rail backs enclose an angle with the direction of gravity of at least approximately 60°, in particular at least approximately 70°, for example at least approximately 80°.

The guide rails of the guide device are preferably installed horizontally.

The rolling element races are preferably arranged adjacently in the horizontal direction.

This is in particular in contrast to the orientation that is conventional in the case of drawer guides, in which case the rolling element races are arranged one above the other in the direction of gravity.

The displacement system is in particular an armrest device. One of the two objects is preferably an armrest element. The further of the two objects is preferably a centre console of a motor vehicle.

The displacement system according to the invention is thus suitable in particular for use in a motor vehicle.

The present invention therefore also relates to a motor vehicle which comprises one or more guide devices, in particular guide devices according to the invention, for mounting components of the motor vehicle displaceably relative to one another.

In particular the vehicle comprises an armrest device which comprises or forms a displacement system according to the invention.

The components of the motor vehicle are then in particular the objects displaceable relative to one another.

The guide device according to the invention and/or the displacement system according to the invention are also preferably suitable for use for pull-out storage compartments and/or trays and/or work surfaces and/or X-Y tables and/or a displaceable, in particular pull-out, boot floor of a motor vehicle.

For example, the guide device may be used for displaceable arrangement of a work surface in a vehicle, in particular a motor vehicle, an aircraft, etc.

Due to the use of a plurality of guide devices oriented in particular transversely or perpendicularly to one another, a displaceability of an object relative to a further object in a plurality of different spatial directions, for example in a plane, is preferably provided.

In further embodiments of a guide device it may be provided that a rolling element cage of the rolling element arrangement is independent of the movement device, in particular not necessarily coupled by means of coupling elements.

It may also be provided, however, that a coupling element, in particular a rotary element, for example a toothed wheel, is arranged on the rolling element cage, in particular is rotatably mounted thereon. Both guide rails are preferably provided with further coupling elements, in particular linear elements, for example toothed racks. This results in a forced coupling between the guide rails and the rolling element cage.

A damping device and/or drive device in particular may be integrated here in the roller element cage and/or arranged thereon.

A rotation axis of the rotary element is to this end preferably parallel to a plane of extent, parallel to which one or more rail backs of the guide rails extend.

Further preferred features and/or advantages of the invention are the subject of the following description and the illustration of an exemplary embodiment in the drawings.

### BRIEF DESCRIPTION OF THE DRAWINGS

FIG. 1 shows a schematic perspective illustration of a guide device;

FIG. 2 shows a schematic plan view of an upper side of the guide device from FIG. 1;

FIG. 3 shows a schematic vertical cross-section through the guide device along line 3-3 in FIG. 2; and

FIG. 4 shows a schematic side view of the guide device from FIG. 1 with viewing direction in the direction of the arrow 4 in FIG. 2

Identical or functionally equivalent elements are provided in all of the figures with the same reference numerals.

### DETAILED DESCRIPTION OF THE DRAWINGS

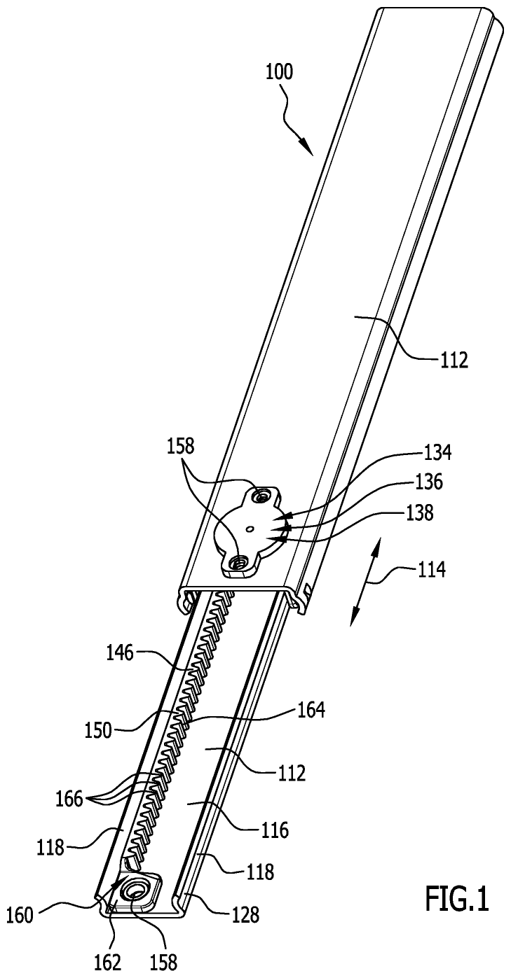

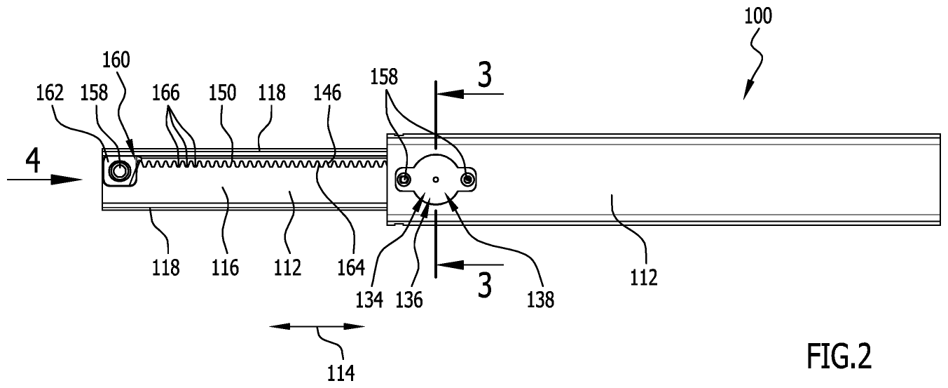

An embodiment of a guide device denoted as a whole by 100 shown in FIG. 1 to 4 is used for example as part of a displacement system 102 in a motor vehicle.

The displacement system 102 is in particular an armrest device 104, in which the guide device 100 is used for the displaceable mounting of an armrest element 106 on a centre console 108.

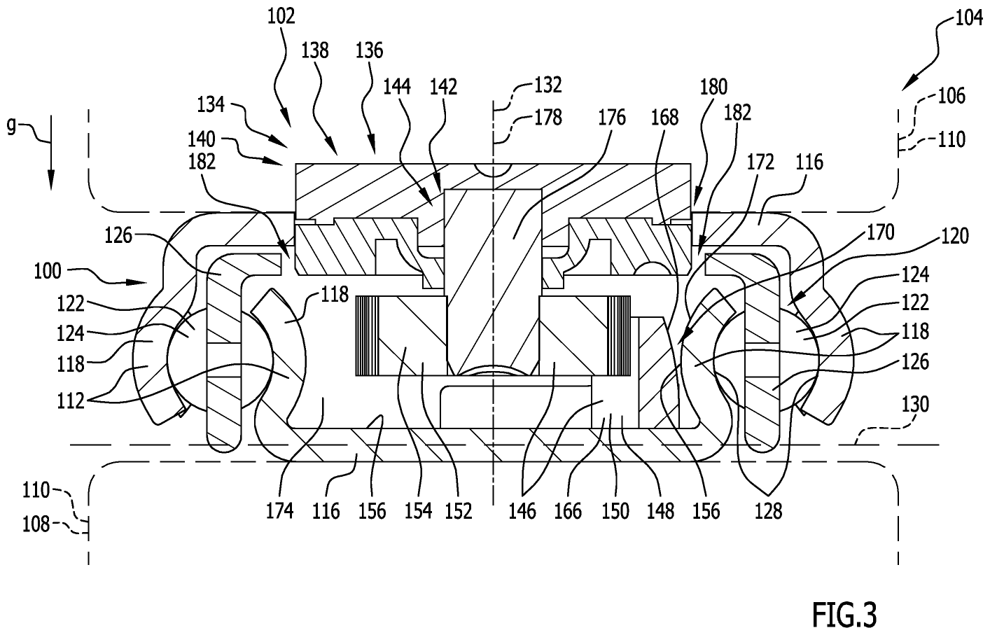

The armrest element 106 and the centre console 108 thus form in particular objects 110, which are displaceable relative to one another by means of the guide device 100 (see in particular FIG. 3).

The guide device 100 preferably comprises two guide rails 112.

More than two guide rails 112, however, for example three, four or more guide rails 112, may also be provided. In particular, a longer displacement path (course of movement) in a displacement direction 114 may be provided as a result of the increased number of guide rails 112.

At least one guide rail 112, in particular both guide rails 112, comprise preferably in each case a rail back 116, which in particular is substantially flat and level.

Two limbs 118 are provided on mutually opposed sides of the rail back 116. The limbs 118 protrude away from the rail back 116, in particular laterally.

The limbs 118 and the rail back 116 on the whole have a cross section of substantially C-shaped design.

The cross section is in particular taken in a plane running perpendicularly to the displacement direction 114.

The two guide rails 112 are mounted displaceably relative to one another by means of a rolling element arrangement 120.

The rolling element arrangement 120 comprises in particular a plurality of rolling elements 122, in particular balls 124.

The rolling elements 122 are positioned relative to one another preferably by means of a rolling element cage 126 and are held rotatably between the two guide rails 112.

The rolling elements 122 can in particular roll along rolling element races 128 of the guide rails 112.

The rolling element races 128 are formed on the limbs 118 of the guide rails 112.

The limbs 118 and the rail back 116 of each guide rail 112 are preferably formed jointly from a one-piece metal sheet material, in particular by shaping a metal strip.

Both rail backs 116 run preferably substantially parallel to one another and parallel to a plane of extent 130.

In the assembled state of the guide device 100, the guide rails 112 are preferably oriented such that the plane of extent 130 is oriented substantially horizontally.

A longitudinal median plane 132 of the guide device 100 running perpendicularly to the plane of extent 130 and along the displacement direction 114 is preferably oriented substantially vertically and thus parallel to the force of gravity g.

The longitudinal median plane 132 is in particular a plane of symmetry of the guide device 100.

In particular, the guide rails 112 and the rolling element arrangement 120 are preferably substantially mirror-symmetrical with respect to the longitudinal median plane 132.

As can be inferred from FIG. 1 to 4, the guide device 100 preferably comprises a movement device 134 for influencing the movement of the guide rails 112 relative to one another.

The movement device 134 is or comprises in particular a damping device 136 and/or a drive device 138.

A movement of one guide rail 112 relative to the further guide rail 112 preferably may be damped by means of the damping device 136. In particular, a desired displacement force and/or a desired resistance during the movement of the guide rails 112 relative to one another may be adjusted and/or selected.

A movement of the guide rail 112 relative to the further guide rail 112 preferably may be automated by means of the drive device 138. In particular a motorised drive may be provided.

The movement device 134 comprises in particular a movement unit 140.

The movement unit 140 is for example formed as a damping unit 142 and/or as a drive unit 144.

In order to influence the movement of the two guide rails 112 relative to one another, these are preferably coupled or couplable to one another.

The movement device 134 to this end comprises in particular one or more coupling elements 146.

In particular, a coupling element 146 is arranged on one guide rail 112 and a further coupling element 146 is arranged on the further guide rail 112.

A coupling element 146 is for example formed as a linear element 148, in particular as a toothed rack 150.

A further coupling element 146 is formed for example as a rotary element 152, in particular as a toothed wheel 154.

The two coupling elements 146 are in engagement with one another (coupled to one another) preferably over an entire maximum displacement path (course of movement).

An influencing of movement may thus be made possible preferably in any desired position of the guide rails 112 relative to one another.

The coupling element 146 formed for example as a toothed rack 150 is arranged preferably on an inner side 156 of a rail back 116 of a guide rail 112. In particular, one or more connection elements 158 for securing the coupling element 146 to the inner side 156 of the rail back 116 are provided.

The connection elements 158 may be, in particular, clip elements, detent elements, rivets, weld spots, adhesive bonding spots and/or screws.

In particular, two connection elements 158 are provided at opposite ends 160 of the coupling element 146.

The coupling element 146 comprises, in particular at the ends 160, two connection portions 162 engaged by the connection elements 158.

In particular, a coupling portion 164 of the coupling element 146 is arranged and/or formed between the two connection portions 162.

The coupling portion 164 is in particular a toothed rack 150 which comprises numerous teeth 166.

The teeth 166 are preferably oriented such that a toothed wheel 154 to be brought into engagement with the toothed rack engages with the toothed rack 150 in a direction running parallel to the plane of extent 130 and perpendicularly to the displacement direction 114.

A rear side of the toothed rack 150 facing away from the teeth 166 is preferably adjacent to a limb 118 of a guide rail 112.

It may be provided that a gap 170 is formed between the toothed rack 150 and the limb 118, in particular to enable tolerance compensation.

It may also be provided, however, that the rear side 168 of the toothed rack 150 abuts directly against the limb 118 temporarily during operation or permanently.

A side of the limb 118 facing the toothed rack 150 is in particular an inner side 156, which in particular is arranged facing away from and/or opposite a rolling element race 128 of the same limb 18.

This inner side 156 of the limb 118 forms in particular a contact face 172 of the limb 118 against which the coupling element 146 abuts.

The coupling element 146 may thus be supported in particular on the limb 118, for example if excessively strong forces act on the coupling element 146 and the coupling element is thus deformed, in particular deflected.

The entire linear element 148 formed as a coupling element 146, in particular the toothed rack 150, is preferably arranged in an intermediate space 174 of the guide device 100.

The intermediate space 174 is in particular the space enclosed by the two rail backs 116 and the limbs 118.

The inner sides 156 of the rail backs 116 and of the limbs 118 are thus the sides of the rail backs and the limbs 118 facing the intermediate space 174.

As can be seen in particular in FIG. 3, the coupling element 146 formed as a rotary element 152, in particular as a toothed wheel 154, is connected to the damping unit 142 or the drive unit 144 by means of a shaft 176.

The damping unit 142 is thus actuated by means of the shaft 146 by rotation of the rotary element 152. Furthermore, a torque generated by the drive unit 144 can be transferred to the rotary element by means of the shaft 176 so as to ultimately move the guide rails 112 relative to one another.

The shaft 176 and the rotary element 152 are in particular mounted rotatably about a rotation axis 178.

The rotation axis 178 runs in particular at least approximately in the longitudinal median plane 132.

The rotation axis 178 is preferably oriented substantially perpendicularly to the plane of extent 130.

The damping unit 142 and/or the drive unit 144 are preferably integrated in a rail back 116 of a guide rail 112.

This rail back 116 of the guide rail 112 to this end comprises in particular an opening 180 for receiving the damping unit 142 or the drive unit 114.

In the embodiment of the guide device 100 shown in FIGS. 1 to 4 the damping unit 142 and/or the drive unit 144 protrudes outwardly from the intermediate space 174 through the opening 180 beyond the rail back 116. However, a fully integrated arrangement is preferably provided, in which the damping unit 142 and/or the drive unit 144, on its upper side facing away from the intermediate space 174, terminates substantially flush with the rail back 116.

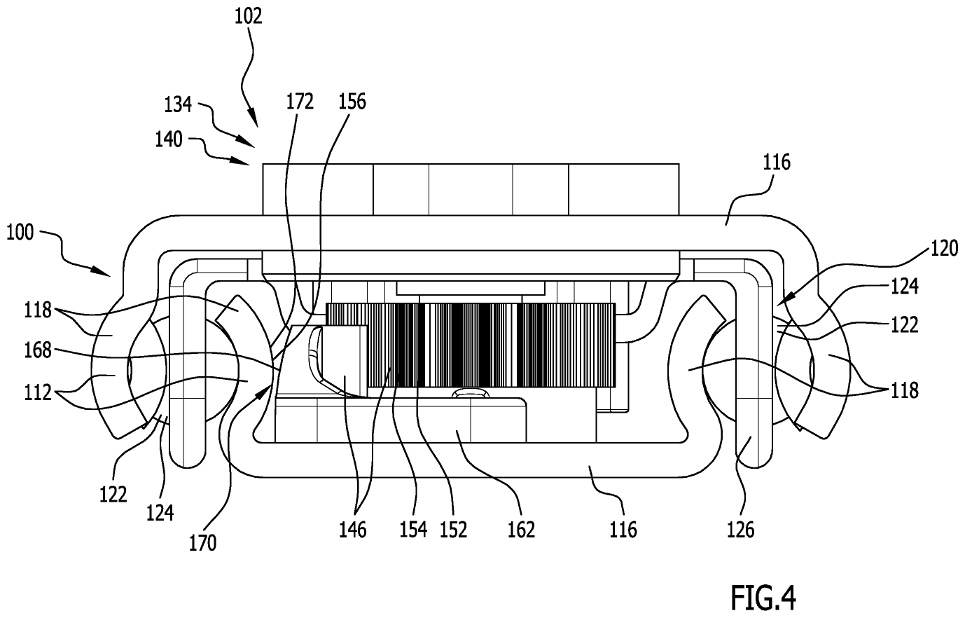

As can also be seen in FIGS. 3 and 4, the rolling element cage 126 preferably has a recess 182.

The two lateral portions of the rolling element cage 126 provided with rolling elements 122 may thus surround the damping unit 142 and/or the drive unit 144.

As a result, the use of a damping device 136 and/or a drive device 138 preferably may be prevented from causing a reduction of the maximum displacement path (course of movement).

In particular, the use of a damping unit 142 preferably enables a relatively stiff actuation, in particular displacement, of the guide rails 112 relative to one another.

For example in the case of use of the guide device 100 for displaceable mounting of an armrest element 106, the armrest element 106 can hereby be prevented from being displaced too easily into undesirable positions or even from changing position automatically as the motor vehicle is accelerated or braked. The use of a drive device 138, by contrast, enables the automated, in particular motorised, displacement of the guide rails 112 relative to one another. As a result, in particular pull-out drawers or boot floors may be actuated particularly comfortably.

Due to the use of guide rails 112 mounted using rolling elements, a high stability of the guide device 100 is also attained. This allows a high mechanical loading of the object 110 to be displaced and also a high level of quality from an optical, acoustic and haptic viewpoint.

### LIST OF REFERENCE NUMERALS

100 guide device

102 displacement system

104 armrest device

106 armrest element

108 centre console

110 object

112 guide rail

114 displacement direction

116 rail back

118 limb

120 rolling element arrangement

122 rolling element

124 ball

126 rolling element cage

128 rolling element race

130 plane of extent

132 longitudinal median plane

134 movement direction

136 damping direction

138 drive device

140 movement unit

142 damping unit

144 drive unit

146 coupling element

148 linear element

150 toothed rack

152 rotary element

154 toothed wheel

156 inner side

158 connection element

160 end

162 connection portion

164 coupling portion

166 tooth

168 rear side

170 gap

172 bearing face

174 intermediate space

176 shaft

178 rotation axis

180 opening

182 recess

g direction of gravity

1. A guide device for displaceably mounting an object on a further object, wherein the guide device comprises the following:
at least two guide rails, which are movable relative to one another by means of a rolling element arrangement;
a movement device for influencing the movement of the at least two guide rails relative to one another.

2. A guide device in accordance with claim 1, wherein each guide rail has a substantially C-shaped cross section and comprises a rail back, from which two limbs provided with rolling element races protrude laterally.

3. A guide device in accordance with claim 1, wherein the movement device comprises a first coupling element and a second coupling element,
wherein the first coupling element and the second coupling element are coupled or couplable to one another in order to influence the movement of the at least two guide rails relative to one another,
wherein the first coupling element is secured directly on or relative to a first guide rail or is formed by a portion or part of the first guide rail, and/or
wherein the second coupling element is secured directly on or relative to a second guide rail or is formed by a portion or part of the second guide rail.

4. A guide device in accordance with claim 3, wherein at least one of the coupling elements extends at least over a maximum displacement path of the guide device, so that the coupling elements are coupled or couplable to one another continuously over the entire displacement path.

5. A guide device in accordance with claim 1, wherein the movement device comprises at least one coupling element which is arranged, in particular secured, on a rail back of one of the guide rails and/or on a limb of one of the guide rails.

6. A guide device in accordance with claim 1, wherein the movement device comprises a coupling element formed as a rotary element, in particular as a toothed wheel, and/or one or more coupling elements formed as linear elements, in particular as toothed racks.

7. A guide device in accordance with claim 6, wherein the rotation axis of the rotary element runs at least approximately perpendicularly to a plane of extent, parallel to which at least one rail back of at least one guide rail extends.

8. A guide device in accordance with claim 1, wherein the movement device comprises one, two or more than two coupling elements, which are arranged fully within an intermediate space formed between the at least two guide rails.

9. A guide device in accordance with claim 1, wherein the movement device comprises a damping device and/or a drive device or is formed as a damping device and/or as a drive device.

10. A guide device in accordance with claim 1, wherein the guide rails are formed mirror-symmetrically with respect to a longitudinal median plane running perpendicularly to rail backs of the two guide rails and along a displacement direction.

11. A displacement system, comprising two objects and a guide device in accordance with claim 1, by means of which one of the two objects is mounted on the further of the two objects so as to be displaceable relative to the further object.

12. A displacement system in accordance with claim 11, wherein the guide device is arranged between the two objects with respect to the direction of gravity.

13. A displacement system in accordance with claim 11, wherein one or more rail backs of guide rails of the guide device are oriented substantially perpendicularly to the direction of gravity or obliquely hereto.

14. A displacement system in accordance with claim 11, wherein the displacement system is an armrest device, wherein one of the two objects is an armrest element, and/or wherein one of the two objects is a centre console of a motor vehicle.

15. A motor vehicle comprising one or more guide device(s) in accordance with claim 1 for mounting components of the motor vehicle displaceably relative to one another.
